(19) United States
(12) Patent Application Publication
(10) Pub. No.: US 2021/0124219 A1
(43) Pub. Date: Apr. 29, 2021

(54) DISPLAY APPARATUS

(71) Applicant: Innolux Corporation, Miao-Li County (TW)

(72) Inventors: Hung-Kun Chen, Miao-Li County (TW); Li-Wei Sung, Miao-Li County (TW)

(73) Assignee: Innolux Corporation, Miao-Li County (TW)

(21) Appl. No.: 17/067,771

(22) Filed: Oct. 12, 2020

(30) Foreign Application Priority Data
Oct. 23, 2019 (CN) 201911014077.3

(51) Int. Cl. G02F 1/1343; G02F 1/1335; G02F 1/1362

(52) U.S. Cl. CPC G02F 1/134309; G02F 2001/134345; G02F 1/136286; G02F 1/133512

(57) ABSTRACT

The disclosure provides a display apparatus having a pixel unit. The pixel unit include a first sub-pixel electrode and a second sub-pixel electrode. The first sub-pixel electrode includes a first main segment extending along a first direction, a first sub-segment extending along a second direction, and a third sub-segment extending along a third direction. The first sub-segment and the second sub-segment are respectively connected with the first main segment and located at two opposite ends of the first main segment. The second sub-pixel electrode is disposed adjacent to the first sub-pixel electrode and includes a second main segment extending along a fourth direction. The first direction is different from the fourth direction, the second direction is different from the first direction, and the third direction is different from the first direction.

### CROSS-REFERENCE TO RELATED APPLICATION

This application claims the priority benefit of China application serial no. 201911014077.3, filed on Oct. 23, 2019. The entirety of the above-mentioned patent application is hereby incorporated by reference herein and made a part of this specification.

### BACKGROUND

### Technical Field

The disclosure relates to an electronic apparatus, particularly to a display apparatus.

### Description of Related Art

With the vigorous development of electronic products, the display technologies applied to electronic products have also been continuously improved. Display apparatuses have been under the development toward display effects with a higher contrast ratio or a higher luminance.

### SUMMARY

The embodiments of the disclosure are directed to a display apparatus with a favorable display quality.

According to an embodiment of the disclosure, a display apparatus includes a pixel unit.

The pixel unit includes a first sub-pixel electrode and a second sub-pixel electrode. The first sub-pixel electrode includes a first main segment extending along a first direction, a first sub-segment extending along a second direction, and a third sub-segment extending along a third direction. The first sub-segment and the second sub-segment are respectively connected with the first main segment and located at two opposite ends of the first main segment. The second sub-pixel electrode is disposed adjacent to the first sub-pixel electrode and includes a second main segment extending along a fourth direction. The first direction is different from the fourth direction, the second direction is different from the first direction, and the third direction is different from the first direction.

In view of the foregoing, the display apparatus according to the embodiments of the disclosure has the pixel unit. The first sub-pixel electrode and the second sub-pixel electrode adjacent in the pixel unit respectively extend in different directions. With such configuration, at least one pixel unit in the display apparatus according to the embodiments is capable of driving liquid crystal molecules to tilt in different directions. Accordingly, liquid crystal molecules tilting in the same or different directions may be provided on adjacent rows or columns. Therefore, through mutual compensation among the pixel units, the display apparatus according to the embodiments of the disclosure is capable of reducing the visual inconsistencies due to strips, effectively decreasing the phenomenon of bright/dark strips, or rendering a favorable display effect with a high contrast ratio or a high luminance, thereby making the display quality of the display apparatus favorable. Besides, the sub-pixel electrode of the embodiment may further include a main segment and a sub-segment extending in different directions. In this way, the dark strips can be reduced, or the rotation efficiency of liquid crystal molecules can be increased, thereby facilitating the response speed and rendering a favorable display quality of the display apparatus.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic top view illustrating a display apparatus according to an embodiment of the disclosure.

FIG. 1B is a schematic partially enlarged view of a region R of FIG. 1A.

FIG. 2 is a schematic partially enlarged view illustrating a pixel unit of a display apparatus according to another embodiment of the disclosure.

FIG. 3 is a partially enlarged photograph of a pixel unit according to another embodiment of the disclosure.

FIG. 4 is a schematic top view illustrating a display apparatus according to another embodiment of the disclosure.

FIG. 5 is a schematic cross-sectional view taken along a cross-sectional line A-A′ of FIG. 4.

FIG. 6 is a schematic top view illustrating a display apparatus according to still another embodiment of the disclosure.

FIG. 7 is a schematic cross-sectional view taken along a cross-sectional line B-B′ of FIG. 6.

FIG. 8 is a schematic top view illustrating a display apparatus according to yet another embodiment of the disclosure.

### DESCRIPTION OF THE EMBODIMENTS

Reference will now be made in detail to the embodiments of the disclosure, examples of which are illustrated in the accompanying drawings. Wherever possible, the same reference numbers are used in the drawings and the description to refer to the same or like parts.

In the disclosure, the description that a structure (or a layer, a component, a substrate, etc.) is located on another structure (or another layer, another component, another substrate, etc.) may indicate that the two structures are adjacent and directly connected with each other, or the two structures are adjacent but not directly connected with each other. The expression “not connected with each other” refers to that at least one intermediate structure (or at least one intermediate layer, component, substrate, spacing, etc.) is provided between the two structures, the lower side surface of one structure is adjacent or directly connected to the upper side surface of the intermediate structure, and the upper side structure of the other structure is adjacent to or directly connected to the lower side surface of the intermediate structure. The intermediate structure may be a physical structure with one or more layers or a non-physical structure. The disclosure is not particularly limited in this regard. In the disclosure, the expression that a structure is disposed “on” another structure may indicate that the structure is “directly” located on the another structure, or the structure is “indirectly” located on the another structure, i.e., at least one further structure is interposed between the structure and the another structure.

In the disclosure, the expression “electrically connected/coupled” or the like may indicate both direct and indirect connection. In the case of direct connection, the terminals of components on two circuits are directly connected or connected via a conductive segment. In the case of indirect connection, a switch, a diode, a capacitor, an inductor, a resistor, other suitable components, or a combination of the aforementioned, to which the disclosure is not particularly limited, is provided between the terminals of the components on the two circuits.

A display apparatus of the disclosure may be considered as an application of an electronic apparatus. The electronic apparatus may include a display apparatus, an antenna apparatus, a light emitting apparatus, a sensing apparatus, a splicing apparatus, other suitable apparatuses, or a combination of the aforementioned. The disclosure is not particularly limited in this regard. The electronic apparatus may be a foldable or flexible electronic apparatus. The electronic apparatus may include liquid crystal, a light emitting diode (LED), fluorescence, phosphor, other suitable materials or a combination of the aforementioned. However, the disclosure is not limited thereto. The LED may include an organic light emitting diode (OLED), a mini LED, a micro LED, or a quantum dot (QD) LED (also referred to as QLED, QDLED, etc.), but the disclosure is not limited thereto. The antenna may be, for example, a liquid crystal antenna. However, the disclosure is not limited thereto. The splicing apparatus may be, for example, a display splicing apparatus or an antenna splicing apparatus. However, the disclosure is not limited thereto. It should be noted that the electronic apparatus may be an arbitrary combination of the foregoing, and the disclosure is not particularly limited in this regard. In the following, as examples, the disclosure is described by considering a display apparatus as an electronic apparatus or a splicing apparatus. However, the disclosure is not limited thereto.

In the disclosure, the various embodiments may be used alone or in combination without departing from the spirit and scope of the disclosure. For example, a part of the feature of an embodiment may be combined with a part of the feature of another embodiment to form yet another embodiment.

In the following, the exemplary embodiments of the disclosure will be described in detail. The examples of the exemplary embodiments are illustrated in the accompanying drawings. Wherever possible, the same reference numbers are used in the drawings and the description to refer to the same or like parts.

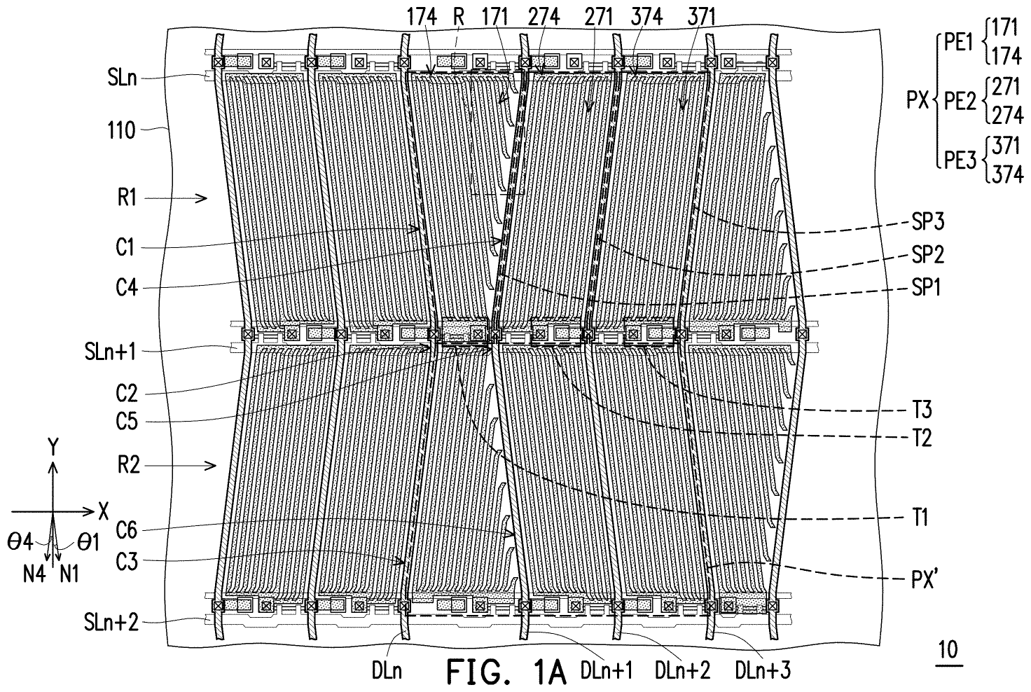

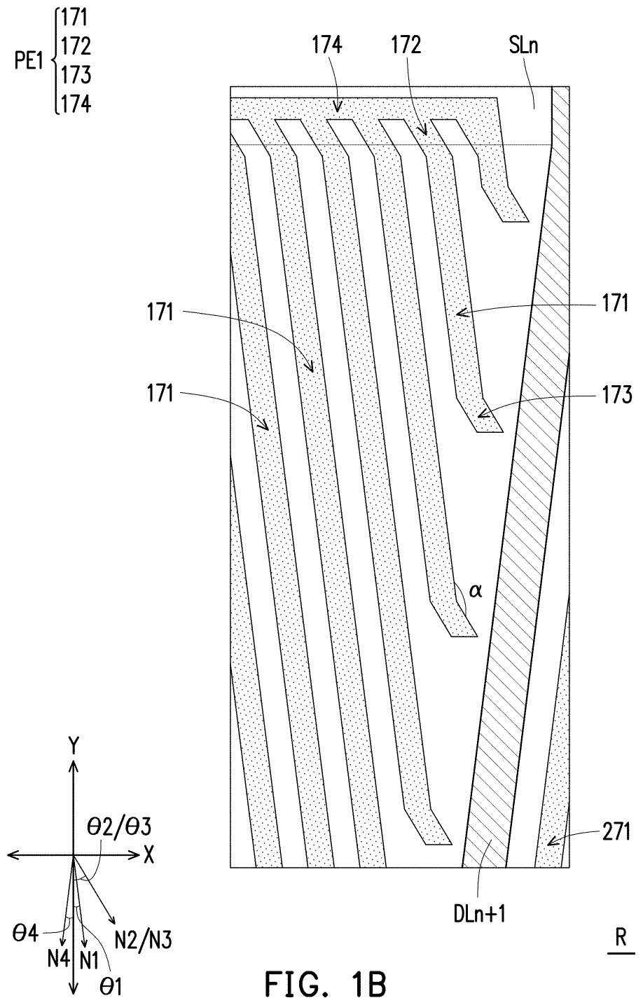

FIG. 1A is a schematic top view illustrating a display apparatus according to an embodiment of the disclosure. FIG. 1B is a schematic partially enlarged view of a region R of FIG. 1A. For the clarity and ease of illustration, some layers and components are omitted in FIGS. 1A and 1B. As shown in FIG. 1A, a display apparatus 10 includes a plurality of pixel units (e.g., pixel units PX, pixel units PX′). The pixel unit PX include a first sub-pixel electrode PE1 and a second sub-pixel electrode PE2. The second sub-pixel electrode PE2 is disposed adjacent to the first sub-pixel electrode PE1. At least one of the pixel units includes two sub-pixel electrodes with different extension directions, or two adjacent sub-pixel electrodes in two adjacent pixel units have different extension directions. In this way, the tilting directions of the liquid crystal molecules corresponding to different sub-pixel electrodes are different, the stripes with varied luminances perceived by human eyes can be reduced, and, as a result, the display quality of the display apparatus is favorable. The display apparatus 10 according to the embodiment of the disclosure renders a display effect with a high contrast ratio or a high luminance, with which of the display apparatus 10 can exhibit a favorable display quality.

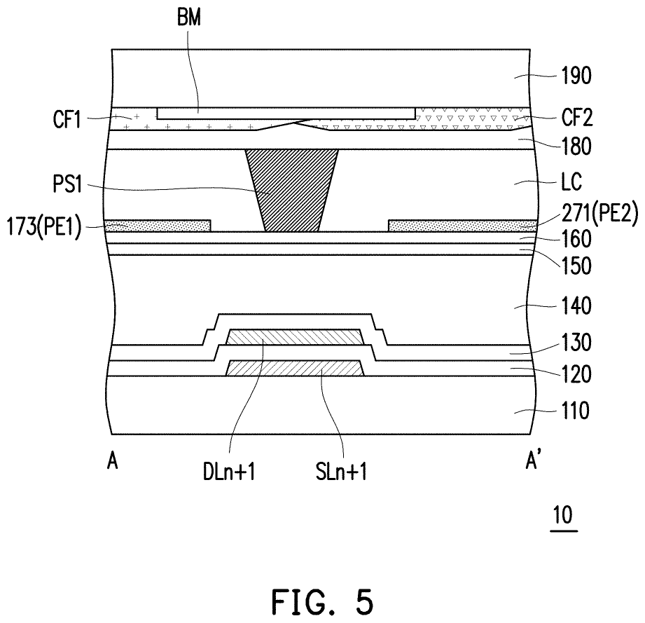

In the embodiment, the display apparatus 10 includes an array substrate 110, an opposite substrate 190 (shown in FIG. 5) and a display medium layer LC (shown in FIG. 5) between the array substrate 110 and the opposite substrate 190. In the embodiment, the material of the display medium layer LC includes a liquid crystal material, an electrowetting display material, an electrophoretic display material, etc., but the disclosure is not limited thereto. The pixel units, such as the pixel unit PX and the pixel unit PX′, are disposed on the array substrate 110 to provide a driving electric field for driving the display medium layer LC and thereby attaining a display effect as desired.

As shown in FIG. 1A, the display apparatus 10 according to the embodiment further includes a plurality of scan lines and data lines intersecting each other. The scan lines and the data lines are disposed on the array substrate 110. The scan lines may respectively extend along a direction X. For example, a scan line SLn is disposed in parallel with a scan line SLn+2, and a scan line SLn+1 is disposed between the scan lines SLn and SLn+2. However, the embodiment is not limited thereto. The data lines (e.g., data lines DLn, DLn+1, DLn+2, DLn+3) may extend along a direction Y and respectively intersect the scan lines. The data lines may form a zigzag pattern, but the disclosure is not limited thereto. For example, the data line DLn is formed by a plurality of segments, including a first segment C1 extending along a first direction N1, for example, a third segment C3 extending a fourth direction N4, for example, and a second segment C2 connected between the first segment C1 and the third segment C3 and extending along the direction Y, for example. In the embodiment, the second segment C2 may be overlapped with the scan line SLn+1. However, the disclosure is not limited thereto. In the embodiment, the direction X is perpendicular to the direction Y. An included angle θ1 of 5 to 20 degrees may be set between the first direction N1 and the direction Y, and an included angle θ4 of 5 to 20 degrees may be set between the fourth direction N4 and the direction Y. The first direction N1 may be different from the fourth direction N4. In some embodiments, the included angle θ1 may be the same as the included angle θ4. For example, the included angle θ1 is 7 degrees, and the included angle θ4 is 7 degrees. With such configuration, two adjacent pixel electrodes may render a display effect of visual compensation to human eyes, thereby making the display quality favorable. However, the disclosure is not limited thereto.

In the embodiment, the data line DLn+1 is substantially similar to the data line DLn. The main difference of the data line DLn+1 from the data line DLn is that a first segment C4 of the data line DLn+1 extends along the fourth direction N4, a second segment C5 extends along the direction Y, and a third segment C6 extends along the first direction N1. The shapes of the data lines DLn+2 and DLn+3 are substantially similar to the shape of the data line DLn+1. However, the embodiment is not limited thereto. With such configuration, not all of the data lines of the embodiment are disposed in the same direction. For example, the extending directions of the segments on the same row (e.g., the first segment C1 and the first segment C4 on a first row R1) may be different, and the extending directions of the segments of the same data line on different rows (e.g., the first segment C1 located on the first row R1 and the third segment C3 adjacent to the first segment C1 and located on the second row R) may be different. However, the embodiment is not limited thereto. In the embodiment, for example, at least the segments of two adjacent data lines among four adjacent data lines on the same row have different extending directions. For example, the first segment C1 extends along the first direction N1, and the fourth segment C4 extends along the second direction N2. However, the disclosure is not limited thereto.

In the embodiment, the scan lines and the data lines may define a plurality of regions in which the sub-pixel electrodes are disposed. For example, a first sub-pixel region SP1 (as shown by the dotted frame in FIG. 1A) may be defined among the scan line SLn, the scan line SLn+1, the data line DLn, and the data line DLn+1. The first sub-pixel electrode PE1 may be correspondingly disposed in the first sub-pixel region SP1. The first sub-pixel electrode PE1 may be coupled to the scan line SLn+1 via a first active device T1. A second sub-pixel region SP2 (as shown by the dotted frame in FIG. 1A) may be defined among the scan line SLn, the scan line SLn+1, the data line DLn+1, and the data line DLn+2. The second sub-pixel electrode PE2 may be correspondingly disposed in the second sub-pixel region SP2. The second sub-pixel electrode PE2 may be coupled to the scan line SLn+1 via a second active device T2. In the embodiment, the first active device T1 and the second active device T2 may be, for example, thin film transistors (TFTs), and may respectively have a gate, an active layer, and a source and a drain (not shown) electrically connected with an active layer. However, the disclosure is not limited thereto.

Referring to FIGS. 1A and 1B, the first sub-pixel electrode PE1 and the second sub-pixel electrode PE2 are disposed in adjacency, and are respectively located on opposite sides with respect to the data line DLn+1. However, the disclosure is not limited thereto. As shown in FIG. 1B, the first sub-pixel electrode PE1 includes at least one first main segment 171, at least one first sub-segment 172 and at least one second sub-segment 173. The first sub-segment 172 and the second sub-segment 173 are respectively connected with the first main segment 171 and located on two opposite ends of the first main segment 171. For example, the first sub-segment 172 may be connected with the upper end of the first main segment 171, and the second sub-segment 173 may be connected with the lower end of the first main segment 171. However, the disclosure is not limited thereto. The first main segment 171 may extend along the first direction N1. The extending direction of the first sub-pixel electrode PE1 is, for example, defined according to the extending direction of the first main segment 171. In other words, the extending direction of the first sub-pixel electrode PE1 may be the first direction N1.

In the embodiment, the second sub-segment 172 extends along the second direction N2, and the second sub-segment 173 extends along the third direction N3. An included angle θ2 of 15 degrees to 45 degrees may be set between the second direction N2 and the direction Y. In the embodiment, the second direction N2 and the third direction N3 may be the same. In other words, an included angle θ3 between the third direction N3 and the direction Y may be the same as the included angle θ2. However, the disclosure is not limited thereto. In some embodiments, the third direction N3 may also be different from the second direction N2, so that the included angle θ3 is different from the included angle θ2.

It should be noted that, in the embodiment, the second direction N2 and the third direction N3 are different from the first direction N1, and the second direction N2 and the third direction N3 are different from the fourth direction N4. For example, an angle a between the first direction N1 in which the first main segment 171 extends and the second direction N2 in which the second sub-segment 173 extends may range from 140 degrees to 185 degrees. In this way, the tilting angle of the liquid crystal molecules corresponding to the second segment 173 can be increased, so as to reduce the dark strips generated in the region near the first sub-pixel electrode PE1 and the data line DLn+1 and make the display quality (e.g., transmittance) of the display apparatus favorable, or to facilitate the rotation efficiency of the liquid crystal molecules and increase the response speed of the display apparatus.

In the embodiment, the first sub-pixel electrode PE1 further includes a connection segment 174. The connection segment 174 is connected with the first sub-segment 172. In the embodiment, the connection segment 174 extends along the direction X, for example. Therefore, the extending direction of the connection segment 174 is different from the first direction N1, the second direction N2, the third direction N3, and/or the fourth direction N4. The first sub-segment 172 is disposed to reduce the dark strips generated in the region near the first main segment 171 and the connection segment 174 and make the display quality of the display apparatus favorable, or to facilitate the rotation efficiency of the liquid crystal molecules and increase the response speed of the display apparatus.

As shown in FIGS. 1A and 1B, a main segment 271 of the second sub-pixel electrode PE2 may extend along the fourth direction N4. The extending direction of the second sub-pixel electrode PE2 may be defined according to the extending direction of the second segment 271, for example. In other words, the extending direction of the second sub-pixel electrode PE2 is the fourth direction N4.

In the pixel unit PX, the first sub-pixel electrode PE1 and the second sub-pixel electrode PE2 that are adjacent to each other respectively extend along the first direction N1 and the fourth direction N4. Accordingly, the extending direction of the first sub-pixel electrode PE1 and the extending direction of the second sub-pixel electrode PE2 may be different. With such configuration, the tilting direction of the liquid crystal molecules corresponding to the first sub-pixel electrode PE1 is different from the tilting direction of the liquid crystal molecules corresponding to the second sub-pixel electrode PE2. In this way, at least one pixel unit PX in the display apparatus 10 according to the embodiment is capable of driving liquid crystal molecules to tilt in different directions. Therefore, the liquid crystal molecules driven by multiple pixel units disposed on the same row (e.g., the first row R1) may tilt at least in correspondence with the first direction N1 or the fourth direction N4, and the same row can be provided with liquid crystal molecules having the same or different tilting directions. In addition, the liquid crystal molecules driven by the pixel unit PX and the adjacent pixel unit PX′ disposed on different rows (e.g., the first row R1 and the second row R2) can tilt in correspondence with the first direction N1 or the fourth direction N4. Accordingly, the adjacent rows can be provided with liquid crystal molecules having the same or different tilting directions. In this way, the display apparatus 10 of the embodiment is capable of reducing the strips or visual inconsistencies resulting from the liquid crystal molecules tilting in the same direction on different rows and thus capable of facilitating the display efficiency, increasing the contrast ratio or luminance, or rending a favorable display quality of the display apparatus 10.

In the embodiment, the pixel unit PX further includes a third sub-pixel electrode PE3. Specifically, the third sub-pixel electrode PE3 is substantially similar to the second sub-pixel electrode PE2. Therefore, the components of the third sub-pixel electrode PE3 that are like or similar to the components of the second sub-pixel electrode PE2 will not be described again in the following. In the embodiment, a third sub-pixel region SP3 (as shown by the dotted frame in FIG. 1A) may be defined between the scan line SLn, the scan line SLn+1, the data line DLn+2, and the data line DLn+3. The third sub-pixel electrode PE3 may be correspondingly disposed in the third sub-pixel region SP3. The third sub-pixel electrode PE3 may be coupled to the scan line SLn+1 via a third active device T3. In the embodiment, the third sub-pixel electrode PE3 and the second sub-pixel electrode PE2 are disposed in adjacency, and are respectively located on opposite sides with respect to the data line DLn+2. However, the disclosure is not limited thereto. A third main segment 371 of the third sub-pixel electrode PE3 may extend along the fourth direction N4. The overall extending direction of the third sub-pixel electrode PE3 may be defined according to the extending direction of the third main segment 371, for example. In other words, the extending direction of the third sub-pixel electrode PE3 is the fourth direction N4. With such configuration, the extending direction of the third sub-pixel electrode PE3 may be the same as the extending direction of the second sub-pixel electrode PE2. In this way, the tilting direction of the liquid crystal molecules corresponding to the third sub-pixel electrode PE3 may be the same as the tilting direction of the liquid crystal molecules corresponding to the second sub-pixel electrode PE2, but different from the tilting direction of the liquid crystal molecules corresponding to the first sub-pixel electrode PE1. When the array substrate 110 is viewed from a top perspective, the first sub-pixel electrode PE1, the second sub-pixel electrode PE2, and the third sub-pixel electrode PE3 may be arranged in a shape that forms a non-rectangular pixel unit PX. In some embodiments, when viewed from the top perspective, the pixel unit PX may be in a shape of a trapezoid, a triangle, a rhombus, other suitable shapes, or a combination thereof. However, the disclosure is not limited thereto.

In the embodiment, the pixel unit PX′ is substantially similar to the pixel unit PX. Therefore, the components in the pixel unit PX′ like or similar to the components in the pixel unit PX will not be described again in the following. In the embodiment, the pixel unit PX′ includes, for example, three sub-pixel electrodes (not shown) and may be defined by the scan line SLn+1, the scan line SLn+2, the data line DLn, and the data line DLn+3. The pixel unit PX′ is disposed between the scan line SLn+1 and the scan line SLn+2, and disposed in correspondence with the pixel unit PX in the direction Y. In other words, the pixel PX′ is disposed adjacent to the pixel unit PX, and the pixel unit PX′ and the pixel unit PX are disposed on opposite sides with respect to the scan line SLn+1. The extending direction of the first sub-pixel electrode of the pixel unit PX′ may be the fourth direction N4, and the extending direction of the second sub-pixel electrode of the pixel unit PX′ may be the first direction N1, and the extending direction of the third sub-pixel electrode of the pixel unit PX′ may be the first direction N1. With such configuration, when viewed from the top perspective, the pixel unit PX′ may also be in a shape of a trapezoid, a triangle, a rhombus, other suitable shapes, or a combination thereof. However, the disclosure is not limited thereto. In this way, the pixel unit PX and the pixel unit PX′ may compensate each other to attain a favorable display quality of the display apparatus 10.

Besides, in the pixel unit PX of the embodiment, the area of the first sub-pixel region SP1 may be substantially equal to the area of the second sub-pixel region SP2. However, the disclosure is not limited thereto. In the embodiment, “substantially equal” may be defined as including a variation of ±10%, but the disclosure is not limited thereto. In some embodiments, the areas of the first sub-pixel region SP1, the second sub-pixel region SP2, and/or the third sub-pixel region SP3 are equal. However, the disclosure is not limited thereto. In some embodiments, the area of the third sub-pixel region SP3 adjacent to the second sub-pixel region SP2 may be smaller than or equal to the area of the second sub-pixel region SP2, the area of the second sub-pixel region SP2 may be smaller than the area of the first sub-pixel region SP1, and the area of the third sub-pixel region SP3 may be smaller than the area of the first sub-pixel region SP1. In some embodiments, the number of the first main segment 171 of the first sub-pixel electrode PE1 is different from the number of the second main segment 271 of the second sub-pixel electrode PE2. For example, the number of the first main segment 171 may be greater than the number of the second segment 271. By doing so, the sub-pixel regions in the pixel unit PX may be adjusted to exhibit different shapes, and/or the design of the sub-pixel electrodes may be adjusted, thereby attaining a favorable display quality of the display apparatus 10.

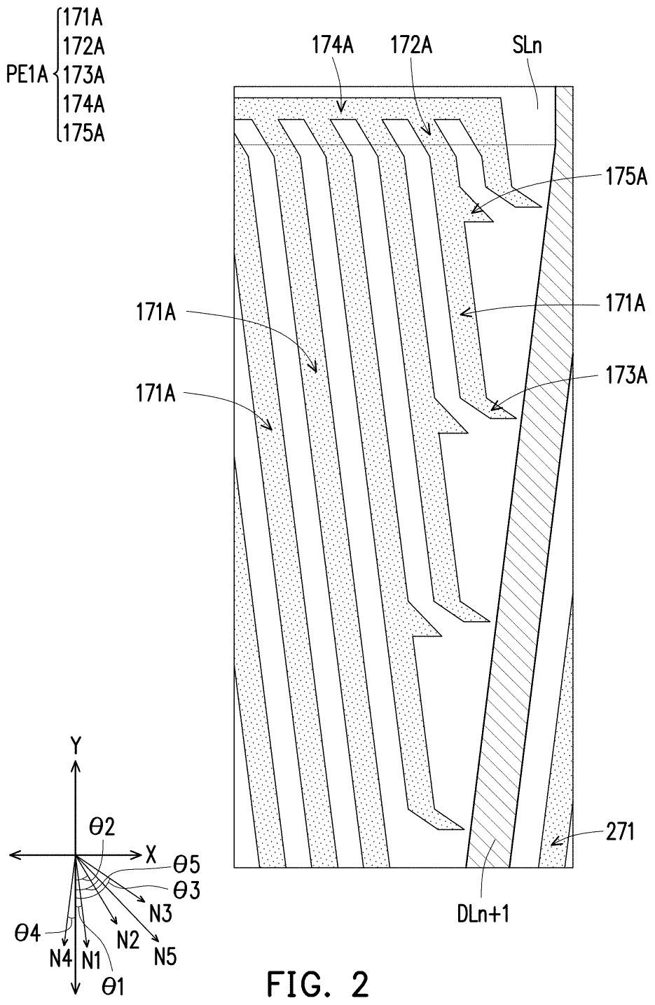

FIG. 2 is a schematic partially enlarged view illustrating a pixel unit of a display apparatus according to another embodiment of the disclosure. A first sub-pixel electrode PE1A of the pixel unit of the embodiment is substantially similar to the first sub-pixel electrode PE1 of FIG. 1B. Therefore, like or similar components shared by the two embodiments will not be repetitively described in the following. The first sub-pixel electrode PE1A of the embodiment mainly differs from the first sub-pixel electrode PE1 of FIG. 1B in that the first sub-pixel electrode PE1A further includes a third sub-segment 175A. The third sub-segment 175A is connected with a first main segment 171A and located between a first sub-segment 172A and a second sub-segment 173A. In the embodiment, the first sub-pixel electrode PE1A further includes a connection segment 174A. The connection segment 174A is connected with the first sub-segment 172A. In the embodiment, the third sub-segment 175A may extend in a fifth direction N5, and the fifth direction N5 may be different from the first direction N1. For example, an included angle θ5 of 15 degrees to 45 degrees may be set between the fifth direction N5 and the direction Y. In the embodiment, the second direction N2, the third direction N3, and the fifth direction N5 may be the same or different from each other. The included angles θ2, θ3, and θ5 may be the same or different from each other. However, the disclosure is not limited thereto. People of ordinary skills in the art shall understand that the disclosure is not particularly limited to the relationship among the second direction N2, the third direction N3 and the fifth direction N5. Specifically, any second direction N2, third direction N3 and fifth direction N5 different from the first direction N1 shall comply with the spirit of or fall within the scope of the disclosure.

With such configuration, the third sub-segment 175A may increase the tilting angle of the liquid crystal molecules corresponding to the third sub-segment 175A and reduce the dark strips, or may increase the rotation efficiency of the liquid crystal molecules to increase the display efficiency (e.g., transmittance) or the response speed of the display apparatus to render a favorable display quality.

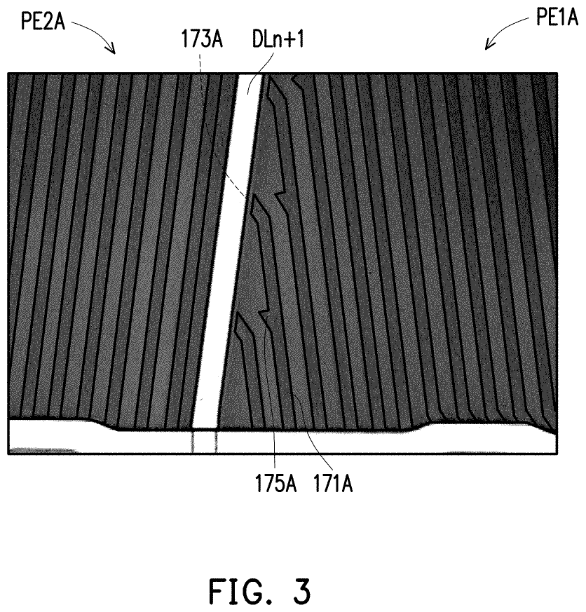

FIG. 3 is a partially enlarged photograph of a pixel unit according to another embodiment of the disclosure. The first pixel electrode of the embodiment has the first main segment 171A extending along the first direction N1, and the first main segment 171A is connected with the second segment 173A and the third segment 175A. In the embodiment, the second sub-segment 173A and the third sub-segment 175A may have a curved shaped edge that leads to a gradual change in the rotation of the liquid crystal molecules in a nearby region. As shown in FIGS. 1B and 2, the second sub-segment 173 and the second sub-segment 173A and the third sub-segment 175A (shown in FIG. 2) may also exhibit an edge in a non-curved shape (e.g., a triangular shape, a rectangular shape, a polygonal shape, or an irregular shape). However, the disclosure is not limited thereto.

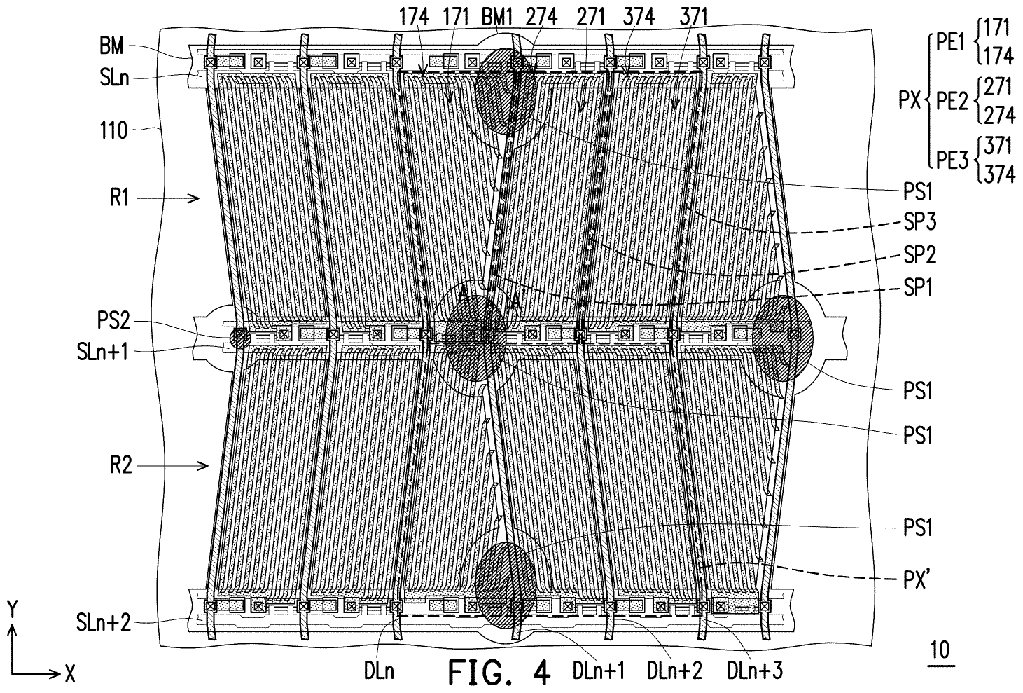

FIG. 4 is a schematic top view illustrating a display apparatus according to another embodiment of the disclosure. FIG. 5 is a schematic cross-sectional view taken along a cross-sectional line A-A′ of FIG. 4. For the clarity and ease of illustration, some layers and components are omitted in FIGS. 4 and 5. Referring to FIGS. 1A, 4, and 5, the display apparatus 10 of the embodiment further includes a light shielding layer BM and a plurality of supports. In the following, the structural relationship among the layers in the display apparatus 10 will be briefly described. In the disclosure, the materials for the respective components of the display apparatus 10 are not particularly limited, that is, any material known in the field may be used, as long as the objective of the disclosure can be attained.

Referring to FIG. 5, the display apparatus 10 may include the array substrate 110, the scan line SLn+1, a gate insulation layer 120, a data line DLn+1, a dielectric layer 130, a planarization layer 140, a common electrode layer 150, a passivation layer 160, a sub-pixel electrode (e.g., the first sub-pixel electrode PE1, the second sub-pixel electrode PE2, or the third sub-pixel electrode PE3), the display medium layer LC, a protection layer 180, a plurality of color filter patterns (e.g., a first color filter pattern CF1, a second color filter pattern CF2), the light shielding layer BM, and the opposite substrate 190 that are arranged in sequence. However, the disclosure is not limited thereto. In some embodiments, the display apparatus 10 may further include an active layer (not shown). The active layer may include low-temperature polysilicon (LTPS), indium gallium zinc oxide (IGZO), amorphous silicon (a-Si). However, the disclosure is not limited thereto. In some embodiments, different active devices may include different active layer materials. However, the disclosure is not limited thereto.

In the embodiment, the array substrate 110 and the opposite substrate 190 may each be a transparent substrate, such as a transparent plastic substrate or a glass substrate. For example, the materials of the array substrate 110 and the opposite substrate 190 may respectively include glass, quartz, sapphire, ceramics, polycarbonate (PC), polyimide (PI), polyethylene terephthalate (PET), glass fiber, other suitable materials, or a combination thereof. However, the disclosure is not limited thereto. In some embodiments, the scan line SLn+1 may include a metal material, such as aluminum, molybdenum, copper, silver, other suitable metals, an alloy of the aforementioned materials, or a combination of the aforementioned materials. However, the disclosure is not limited thereto. In some embodiments, the material of the gate insulating layer 120 may include an inorganic material, an organic material, other suitable materials, or a combination of the aforementioned materials. However, the disclosure is not limited thereto. In some embodiments, the data line DLn+1 may include a metal material, such as aluminum, molybdenum, copper, silver, other suitable metals, an alloy of the aforementioned materials, or a combination of the aforementioned materials. However, the disclosure is not limited thereto. In some embodiments, the dielectric layer 130 may include an inorganic material, an organic material, other suitable materials, or a combination of the aforementioned materials. However, the disclosure is not limited thereto. In some embodiments, the planarization layer 140 may include a perfluoroalkoxy (PFA) polymer resin, a polymer film on array, fluoroelastomers, an inorganic material, an organic material, other suitable materials, or a combination of the aforementioned materials. However, the disclosure is not limited thereto. In the embodiment, the thickness of the planarization layer 140 may be greater than the thickness of the gate insulating layer 120 or the thickness of the dielectric layer 130. However, the disclosure is not limited thereto. In some embodiments, the common electrode layer 150 may include a metal material, such as aluminum, molybdenum, copper, silver, other suitable metals, an alloy of the aforementioned materials, or a combination of the aforementioned materials. However, the disclosure is not limited thereto. The material of the common electrode layer 150 may also include a transparent conductive oxide, such as an indium tin oxide, an indium zinc oxide, an aluminum zinc oxide, other suitable materials, or a combination of the aforementioned materials. However, the disclosure is not limited thereto. In some embodiments, the passivation layer 160 may include an inorganic material, an organic material, other suitable materials, or a combination of the aforementioned materials. However, the disclosure is not limited thereto. The inorganic material may be, for example, but not limited to, silicon oxide, silicon nitride, silicon oxynitride, or a stacked layer of at least two of the aforementioned materials. The inorganic material may be, for example, but not limited to, polymer materials, such as a polyimide-based resin, an epoxy-based resin, or an acrylic-based resin, etc. In some embodiments, the first sub-pixel electrode PE1, the second sub-pixel electrode PE2, and the third sub-pixel electrode PE3 may include a transparent conductive oxide, such as an indium tin oxide, an indium zinc oxide, an aluminum zinc oxide, other suitable materials, or a combination of the aforementioned materials. However, the disclosure is not limited thereto.

In some embodiments, the light shielding layer BM is disposed on the opposite substrate 190. The light shielding layer BM may be a black matrix, for example. However, the disclosure is not limited thereto. The color filter patterns are disposed on the opposite substrate 190. The color filter patterns include the first color filter pattern CF1, the second color filter pattern CF2, and a third color filter pattern CF3 (not shown). The first color filter pattern CF1, the second color filter pattern CF2, and the third color filter pattern CF3 may be disposed in correspondence with the first sub-pixel region SP1, the second sub-pixel region SP2, and the third sub-pixel region SP3, respectively, to respectively define sub-pixels of different color lights. For example, the first sub-pixel region SP1 corresponding to the first color filter pattern CF1 may serve as a blue sub-pixel, the second sub-pixel region SP2 corresponding to the second color filter pattern CF2 may serve as a red sub-pixel, and the third sub-pixel region SP3 corresponding to the third color filter pattern CF3 may serve as a green sub-pixel. In some embodiments, the first sub-pixel region SP1, the second sub-pixel region SP2, and the third sub-pixel region SP3 may also respectively correspond to sub-pixels of yellow light, orange light, white light, or other suitable color lights. However, the disclosure is not limited thereto.

In some embodiments, the protection layer 180 may be disposed on the opposite substrate 190 and cover the light shielding layer BM and the color filter patterns. The protection layer 180 may include an inorganic material, an organic material, other suitable materials, or a combination of the aforementioned materials. However, the disclosure is not limited thereto. In the embodiment, the light shielding layer BM, the color filter patterns, and the protection layer 180 are located between the array substrate 110 and the opposite substrate 190. In addition, there may be another layer, such as an alignment layer, a quantum dot (QD) layer, etc., disposed between the array substrate 110 and the display medium layer LC or between the opposite substrate 190 and the display medium layer LC. However, the disclosure is not limited thereto.

The light shielding layer BM of the embodiment may be overlapped with the scan line SLn, the scan line SLn+1, the scan line SLn+2 and/or the data line DLn, the data line DLn+1, the data line DLn+2, and the data line DLn+3, and may be partially overlapped with the second sub-segment 173 of the first sub-pixel electrode PE1 in the first sub-pixel region SP1. As shown in FIGS. 4 and 5, the width of the light shielding layer BM overlapped with the data line DLn+1 may be greater than the width of the light shielding layer BM overlapped with the data line DLn. In the disclosure, the width is defined as the maximum width of the light shielding layer BM overlapped with the data line DLn in the direction X, or the maximum width of the light shielding layer BM overlapped with the data line DLn+1 in the direction X. With such configuration, the light shielding layer BM may be partially overlapped with the second sub-segment 173. Accordingly, the region near the data line DLn+1 and corresponding to the second sub-segment 173 may be partially shielded by the light shielding layer BM. As a result, the dark strips on the edge of the sub-pixel electrodes which the user observes can be reduced, the contrast ratio of the pixel unit PX can be increased, or the display quality of the display apparatus 10 can be ensured.

In addition, the light shielding layer BM of the embodiment may be further provided with a protrusion part BM1 disposed at the part where the scan line and the data line corresponding to the first sub-pixel region SP1 and the second sub-pixel region SP2 are overlapped. From the top perspective, the protrusion part BM1 may exhibit a curved shaped edge. However, the disclosure is not limited thereto. In some embodiments, the shape of the protrusion part BM1 from the top perspective may also be a rectangular shape, a triangular shape, or other irregular shapes. In the embodiment, the protrusion part BM1 may be oval-shaped, and the width of the protrusion part BM1 may range from 10 micrometers to 150 micro meters (i.e., 10 micrometers<width of protrusion part BM1<150 micrometers), or the width of the protrusion part BM1 may range from 40 micrometers to 100 micro meters (i.e., 40 micrometers<width of protrusion part BM1<100 micrometers). However, the disclosure is not limited thereto. In the embodiment, the width may be defined as the maximum width of the protrusion part BM1 from the top perspective.

In the embodiment, since the protrusion part BM1 is disposed in correspondence with the first sub-pixel region SP1 and the second sub-pixel region SP2, the area of the first sub-pixel region SP1 may be different from the area of the second sub-pixel region SP2. For example, the area of the first sub-pixel region SP1 may be greater than the area of the second sub-pixel region SP2. With such configuration, the aperture ratios of the first sub-pixel region SP1 and the second sub-pixel region SP2 may be adjusted through the location where the protrusion part BM1 is disposed, thereby attaining a favorable display quality of the display apparatus 10. For example, the aperture ratio of the first sub-pixel region SP1 is defined as a region in which the first sub-pixel region SP1 is not overlapped with the light shielding layer BM and the protrusion part BM1, i.e., the region in which the first sub-pixel region SP1 is able to substantially display luminance changes. In other embodiments, the area of the second sub-pixel region SP2 may be the same or different from the area of the third sub-pixel region SP3. For example, the area of the second sub-pixel region SP2 may be equal to or greater than the area of the third sub-pixel region SP3. In some other embodiments, the area of the first sub-pixel region SP1 may be greater than the area of the third sub-pixel region SP3. In other words, the area of the first sub-pixel region SP1 may be respectively greater than the area of the second sub-pixel region SP2 and the area of the third sub-pixel region SP3. Accordingly, by adjusting the apertures ratios of the first sub-pixel region SP1, the second sub-pixel region SP2, and the third sub-pixel region SP3 of the display apparatus 10 to be substantially similar or the same, the display apparatus 10 can attain a favorable display quality. In other embodiments, the apertures ratios of the first sub-pixel region SP1, the second sub-pixel region SP2, and the third sub-pixel region SP3 of the display apparatus 10 may be adjusted to be different from one another based on practical situations, so as to attain a desired display effect. The disclosure is not particularly limited in this regard.

Referring to FIGS. 4 and 5, in the embodiment, the supports of the display apparatus 10 may be disposed between the array substrate 110 and the opposite substrate 190. The supports are, for example, photo spacers or columnar spacers. The supports include, for example, a plurality of first supports PS1 and a plurality of second supports PS2. The first supports PS1 and the second supports PS2 are respectively disposed to be overlapped with the protrusion part BM1. In some embodiments, the shape of the first supports PS1 or the second supports PS2 from the top perspective may also be oval-shaped, circular-shaped, cross-shaped, rectangular shape, triangular shape, or other irregular shapes, but the embodiment is not limited thereto. In the embodiment, the width of the first support PS1 may be greater than or equal to the width of the second support PS2. In the embodiment, the width may be defined as the maximum width of the first support PS1 or the second support PS2. For example, the width of the first support PS1 may range from 10 micrometers to 80 micrometers (10 micrometers<width of the first support PS1<80 micrometers), or the width of the first support PS1 may range from 20 micrometers to 60 micrometers (20 micrometers<width of the first support PS1<60 micrometers). The width of the second support PS2 may range from 5 micrometers to 30 micrometers (5 micrometers<width of the second support PS2<30 micrometers), or the width of the second support PS2 may range from 10 micrometers to 25 micrometers (10 micrometers<width of the second support PS2<25 micrometers). However, the disclosure is not limited thereto.

In the embodiment, the supports (including the first supports PS1 or the second supports PS2) may be disposed to be overlapped with the protrusion part BM1, and may be shielded by the light shielding layer BM and/or the protrusion part BM1 without being seen by the user. In addition, the first support PS1 is partially overlapped with the first sub-pixel region SP1 and the second sub-pixel region SP2. For example, the area in which the first support PS1 is overlapped with the first sub-pixel region SP1 may be different from the area in which the first support PS1 is overlapped with the second sub-pixel region SP2. However, the disclosure is not limited thereto. For example, the area in which the first support PS1 is overlapped with the first sub-pixel region SP1 may be greater than the area in which the first support PS1 is overlapped with the second sub-pixel region SP2. However, the disclosure is not limited thereto.

Since the area of the first sub-pixel region SP1 is different from the area of the second sub-pixel region SP2, the influence of the protrusion part BM1 on the aperture ratios of the first sub-pixel region SP1 and the second sub-pixel region SP2 can be reduced. Besides, the aperture ratios of the first sub-pixel region SP1 and the second sub-pixel region SP2 may also be adjusted by using the light shielding layer BM and/or the protrusion part BM1, so that the aperture ratios of the respective sub-pixel regions in the pixel unit PX are substantially the same, thereby facilitating the contrast ratio and/or luminance or attaining a favorable display quality of the display apparatus 10.

In other embodiments, the aperture ratio of the third sub-pixel region SP3 may be adjusted by using the light shielding layer BM and/or the protrusion part BM1, so that the aperture ratios of the first sub-pixel region SP1, the second sub-pixel region SP2, and the third sub-pixel region SP3 of the pixel unit PX may be substantially the same, thereby facilitating the contrast ratio and/or luminance or attaining a favorable display quality of the display apparatus 10. In some other embodiments, the area in which the first support PS1 is overlapped with the first sub-pixel region SP1 may also be the same as the area in which the first support PS1 is overlapped with the second sub-pixel region SP2, so as to adjust the aperture ratios of the sub-pixel regions according to the user's needs, thereby adjusting the contrast ratio and/or luminance and attaining a favorable display quality of the display apparatus 10.

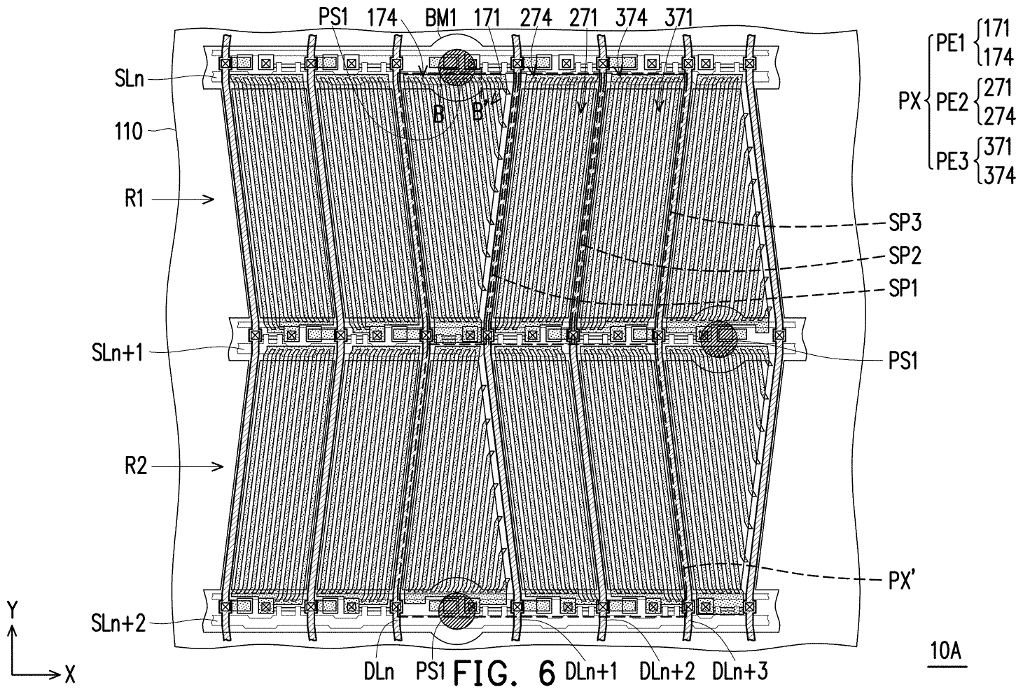

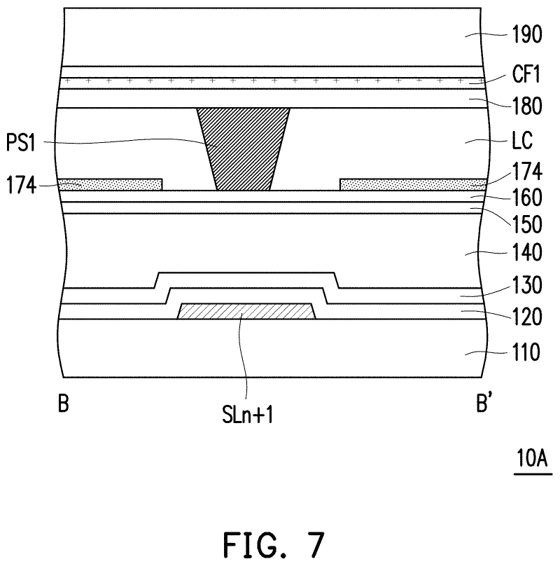

FIG. 6 is a schematic top view illustrating a display apparatus according to still another embodiment of the disclosure. FIG. 7 is a schematic cross-sectional view taken along a cross-sectional line B-B′ of FIG. 6. For the clarity and ease of illustration, some layers and components are omitted in FIGS. 6 and 7. Referring to FIGS. 4, 6, and 7, a display apparatus 10A of the embodiment is substantially similar to the display apparatus 10 of FIG. 4. Therefore, like or similar components shared by the two components will not be repetitively described in the following. The embodiment mainly differs from the display apparatus 10 in that the protrusion part BM1 of the light shielding layer BM is disposed in correspondence with the first sub-pixel region SP1. Compared with the protrusion part BM1 of the display apparatus 10, the protrusion part BM1 of the embodiment is overlapped with the scan line SLn, the scan line SLn+1, and the scan line SLn+2 without being overlapped with the data lines (e.g., the data line DLn, but the disclosure is not limited thereto). From another perspective, the protrusion part BM1 may be overlapped with a portion of the first sub-pixel electrode PE1, including a portion of the connection segment 174 and the first sub-segment 171. However, the disclosure is not limited thereto. In some embodiments, the protrusion part BM1 may also be partially overlapped with the second sub-pixel region SP2 disposed adjacent to the first sub-pixel region SP1. As shown in FIGS. 6 and 7, the first support PS1 may be disposed in correspondence with the protrusion part BM1 and overlapped with the scan line SLn. In other words, the first support SP1 is partially overlapped with the first sub-pixel region SP1.

In the embodiment, the area of the first sub-pixel region SP1 may be optionally set to be different from the area of the second sub-pixel region SP2. For example, the area of the first sub-pixel region SP1 may be greater than the area of the second sub-pixel region SP2. In addition, the area of the second sub-pixel region SP2 may be optionally set to be the same as the area of the third sub-pixel region SP3, such as the area of the second sub-pixel region SP2 being equal to the area of the third sub-pixel region SP3. However, the disclosure is not limited thereto. In other words, in the embodiment, the area of the first sub-pixel region SP1 may be respectively greater than the area of the second sub-pixel region SP2 and the area of the third sub-pixel region SP3. The aperture ratio of the first sub-pixel region SP1, the second sub-pixel region SP2, or the third sub-pixel region SP3 may be adjusted through the location where the protrusion part BM1 is disposed, thereby attaining a favorable display quality of the display apparatus 10.

In the embodiment, the first sub-pixel region SP1 may serve as a blue sub-pixel, and the first support PS1 is disposed on the blue sub-pixel. Since human eyes are visually less sensitive to the color of blue, the aperture ratio may be increased by correspondingly disposing the first support PS1 and/or the protrusion part BM1 on the blue sub-pixel and/or reducing the size of the light shielding layer BM on the sub-pixel corresponding to red or green (e.g., the second sub-pixel region SP2 or the third sub-pixel region SP3).

In the embodiment, the first support PS1 may not be overlapped with an active device (not shown) or not overlapped with the source, the drain, or the semiconductor layer in the active device. In this way, the chance that the active device is squeezed and damaged can be reduced, and a favorable display quality of the display apparatus 10 can be attained.

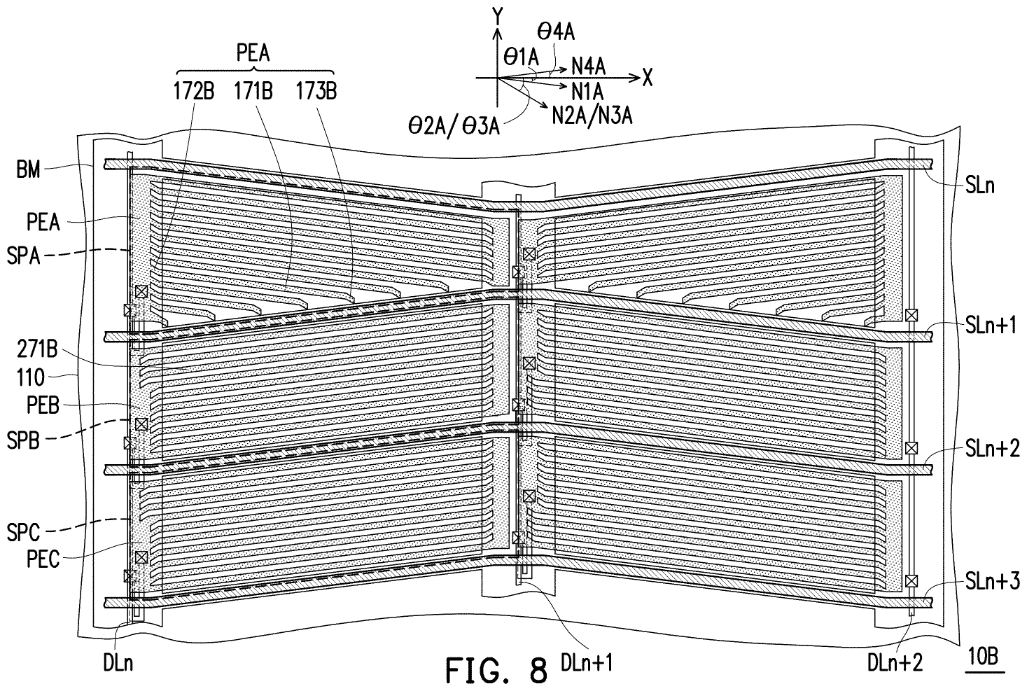

FIG. 8 is a schematic top view illustrating a display apparatus according to yet another embodiment of the disclosure. For the clarity and ease of illustration, some layers and components are omitted in FIG. 8. Referring to FIGS. 1A, and 8, a display apparatus 10B of the embodiment is substantially similar to the display apparatus 10 of FIG. 1A. Therefore, like or similar components shared by the two components will not be repetitively described in the following. The embodiment mainly differs from the display apparatus 10 in that the data line DLn, the data line DLn+1, and the data line DLn+2 extend along the direction Y, and the scan line SLn, the scan line SLn+1, the scan line SLn+2, and the scan line SLn+3 respectively intersect the data line DLn, the data line DLn+1, and the data line DLn+2. In other words, the scan line SLn, the scan line SLn+1, the scan line SLn+2, and the scan line SLn+3 substantially extend along the direction X to form a zigzag shape. With such configuration, compared with the display apparatus 10, the total number of data lines of the display apparatus 10B of the embodiment may be, for example, one-third of the total number of data lines of the display apparatus 10. Also, compared with the display apparatus 10, the total number of scan lines of the display apparatus 10B of the embodiment may be, for example, three times of the total number of scan lines of the display apparatus 10. In other words, the circuit design of the display apparatus 10B of the embodiment is one also referred to as a tri-gate design.

In the embodiment, a first main segment 171B of a first sub-pixel electrode PEA extends along a first direction N1A. A first sub-segment 172B connected with the first main segment 171B extends along a second direction N2A, and a second sub-segment 173B connected with the first main segment 171B extends along a third direction N3A. An included angle θ1A of 5 to 20 degrees may be set between the first direction N1A and the direction X, and an included angle θ2A of 15 to 45 degrees may be set between a second direction N2A and the direction X. In the embodiment, the second direction N2A and the third direction N3A may be the same. In other words, an included angle θ3A between the third direction N3A and the direction X may be the same as the included angle θ2A. However, the disclosure is not limited thereto. In some embodiments, the third direction may also be different from the second direction. Besides, a second main segment 271B of a second sub-pixel electrode PEB extends along a fourth direction N4A. In the embodiment, the first direction N1A may be different from the fourth direction N4A, the second direction N2A may be different from the first direction N1A, and the third direction N3A may be different from the first direction N1A. In this way, a favorable display quality of the display apparatus 10 can be attained. Besides, in the display apparatus 10B, the first sub-pixel electrode PEA, the second sub-pixel electrode PEB, and a third sub-pixel electrode PEC can be driven with the design of one data line DLn. Therefore, the number of driver integrated circuits (ICs) can be reduced, and the cost is therefore lower. Moreover, in another embodiment, the first sub-pixel electrode PEA, the second sub-pixel electrode PEB, and the third sub-pixel electrode PEC can be driven and/or electrically connected by adopting the design of a gate-on-array (GOA) substrate, thereby allowing a slim bezel.

In view of the foregoing, the display apparatus according to the embodiments of the disclosure has the pixel unit. The first sub-pixel electrode and the second sub-pixel electrode adjacent in the pixel unit respectively extend in different directions. With such configuration, the tilting direction of the liquid crystal molecules corresponding to the first sub-pixel electrode may be different from the tilting direction of the liquid crystal molecules corresponding to the second sub-pixel electrode, so as to reduce bright/dark strips, alleviate the visual perception of strips, or render a favorable display quality of the display apparatus. In addition, the pixel electrode according to the embodiments is provided with the main and sub-segments extending in different directions. Accordingly, the rotation efficiency of liquid crystal molecules can be increased, thereby facilitating the display efficiency, increasing the contrast ratio and the luminance, or rendering a favorable display quality of the display apparatus. Besides, in the display apparatus according to the embodiments of the disclosure, by adjusting the location and/or area in which the light shielding layer and/or the support is overlapped with the sub-pixel region, the aperture ratio of the sub-pixel region can be adjusted to render a favorable display quality of the display apparatus.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A display apparatus, having a pixel unit, wherein the pixel unit comprises:
a first sub-pixel electrode, comprising:
a first main segment, extending along a first direction;
a first sub-segment, extending along a second direction; and
a second sub-segment, extending along a third direction,
wherein the first sub-segment and the second sub-segment are respectively connected with the first main segment and are located at two opposite ends of the first main segment; and
a second sub-pixel electrode, disposed adjacent to the first sub-pixel electrode and comprising:
a second main segment, extending along a fourth direction,
wherein the first direction is different from the fourth direction, the second direction is different from the first direction, and the third direction is different from the first direction.

2. The display apparatus as claimed in claim 1, wherein the first sub-pixel electrode further comprises:
a connection segment, connected with the first sub-segment, wherein an extending direction of the connection segment is different from the first direction, the second direction, the third direction, or the fourth direction.

3. The display apparatus as claimed in claim 1, wherein the first sub-pixel electrode further comprises a third sub-segment, the third sub-segment is connected with the first main segment, and the third sub-segment is located between the first sub-segment and the second sub-segment.

4. The display apparatus as claimed in claim 3, wherein, the third sub-segment has a curved shaped edge.

5. The display apparatus as claimed in claim 3, wherein the third sub-segment extends along a fifth direction and the fifth direction is different from the first direction.

6. The display apparatus as claimed in claim 5, wherein the fifth direction is the same as or different from the second direction.

7. The display apparatus as claimed in claim 5, wherein the fifth direction is the same as or different from the third direction.

8. The display apparatus as claimed in claim 1, wherein the pixel unit further comprises a third sub-pixel electrode disposed adjacent to the second sub-pixel electrode, wherein the first sub-pixel electrode corresponds to a first sub-pixel region, the second sub-pixel electrode corresponds to a second sub-pixel region, the third sub-pixel electrode corresponds to a third sub-pixel region, and areas of the first sub-pixel region, the second sub-pixel region, and the third sub-pixel region are substantially equal.

9. The display apparatus as claimed in claim 8, further comprising a support partially overlapped with the first sub-pixel region.

10. The display apparatus as claimed in claim 8, further comprising a support partially overlapped with the first sub-pixel region and the second sub-pixel region.

11. The display apparatus as claimed in claim 10, wherein an area in which the support is overlapped with the first sub-pixel region is greater than an area in which the support is overlapped with the second sub-pixel region.

12. The display apparatus as claimed in claim 9, wherein the shape of the support is oval-shaped, circular-shaped, or cross-shaped.

13. The display apparatus as claimed in claim 9, further comprising a light shielding layer, the light shielding layer comprises a protrusion part, wherein the support is disposed to be overlapped with the protrusion part.

14. The display apparatus as claimed in claim 1, wherein the pixel unit further comprises a third sub-pixel electrode disposed adjacent to the second sub-pixel electrode, wherein the first sub-pixel electrode corresponds to a first sub-pixel region, the second sub-pixel electrode corresponds to a second sub-pixel region, the third sub-pixel electrode corresponds to a third sub-pixel region, an area of the third sub-pixel region is smaller than or equal to an area of the second sub-pixel region, and the area of the second sub-pixel region or the area of the third sub-pixel region is smaller than an area of the first sub-pixel region.

15. The display apparatus as claimed in claim 1, wherein a number of the first main segment of the first sub-pixel electrode is different from a number of the second main segment of the second sub-pixel electrode.

16. The display apparatus as claimed in claim 1, wherein the second sub-segment has a curved shaped edge.

17. The display apparatus as claimed in claim 1, wherein the second direction is the same as or different from the third direction.

18. The display apparatus as claimed in claim 1, further comprising a plurality of scan lines, and a plurality of data lines, the scan lines and the data lines intersect each other, and segments of the data lines extend along the first direction or extend along the fourth direction.

19. The display apparatus as claimed in claim 18, wherein at least one of the data lines forms a zigzag pattern.

20. The display apparatus as claimed in claim 1, wherein an angle is between the first direction and the second direction, the angle ranges from 140 degrees to 185 degrees.
